(19) United States
(12) Patent Application Publication
(10) Pub. No.: US 2025/0238708 A1
(43) Pub. Date: Jul. 24, 2025

(54) Methods And Systems For Managing Artificial Intelligence And Machine Learning Datasets In Cloud Storage

(71) Applicant: Google LLC, Mountain View, CA (US)

(72) Inventors: Nimish Aggarwal, Redmond, WA (US); Avinash Belur, Bellevue, WA (US); Rajaprabhu Thiruchi Loganathan, Bellevue, WA (US); Jonathan Edward Hughes, Seattle, WA (US); Vivek Radhakrishnan, Seattle, WA (US); Muhammad Omer Iqbal, Dubai (AE)

(21) Appl. No.: 18/418,904

(22) Filed: Jan. 22, 2024

(51) Int. Cl. G06N 20/00

(52) U.S. Cl. CPC G06N 20/00

(57) ABSTRACT

Aspects of the disclosure are directed to methods, systems, and computer readable media for managing artificial intelligence and machine learning (“AI/ML”) datasets in cloud storage, especially for creating and controlling bookmarks or other references in cloud storage for a dataset selected for use for training ML models. Bookmarks are sets of object references that are used as a training data for the ML model. The bookmarks serve as a means for the ML platform to preserve a collection of objects in a cloud storage bucket. The bookmarks serve as references to objects in the buckets to preserve a dataset, instead of continuously replicating the objects selected for training. Bookmarks are used for grouping, providing access, and downloading objects in bulk. The ML platform can also grant buckets or bookmarks permission to make data accessible to specified entities.

### BACKGROUND

A machine learning (“ML”) platform is an integrated set of technologies that develop, train, deploy, and refresh ML models. The ML platform can be configured to collect and refine data into a format suitable for the ML model training. The ML model training is a highly iterative process, and each iteration involves selecting a dataset which has been cleaned and is well annotated. Typically, a sizable catalog of files stored in cloud storage is selected for the ML model training. These datasets are either selected manually or via a ML platform. After selection, these datasets are copied to a different storage and the ML platform is then given access to the copied dataset for training. This process is highly inefficient as copying data to a separate storage for each training iteration can cause increased latency, and redundant data duplication. Furthermore, it is challenging to grant the artificial intelligence (“AI”) engine granular access to the partial dataset. Additionally, the entire data can be shared with the ML platform, which increases privacy issues, which is especially troublesome when the dataset contains sensitive, personally identifiable information.

### BRIEF SUMMARY

Aspects of the disclosure are directed to a machine learning (“ML”) platform, using bookmarks or other references to control datasets in cloud storage specifically designed for the ML model training. The ML platform includes managing artificial intelligence and machine learning (“AI/ML”) datasets in cloud storage, especially for creating and controlling references, such as bookmarks, to objects stored in cloud storage buckets to construct AI/ML datasets for the ML model training. The ML platform can store finalized datasets in a version-enabled single bucket. The ML platform can update the objects of the datasets using the bookmark without duplicating objects to another bucket. The ML platform further includes streaming the objects of a dataset to the local memory of the ML platform using a bookmark via application programming interfaces (“APIs”) that are optimized for high read throughput with low latency.

An aspect of the disclosure provides for a method for managing AI/ML datasets in cloud storage, the method including: selecting, by one or more processors, a plurality of objects for training a machine learning model; processing, by one or more processors, the plurality of objects by composing a dataset with the plurality of objects; exporting, by one or more processors, the dataset to a bucket in a cloud storage; and creating, by one or more processors, a bookmark, wherein the bookmark comprises references to at least one of the plurality of objects.

In an example, the bookmark is created in a specific bucket of the cloud storage. In another example, the references are uniform resource identifiers (“URIs”), comprising names and versions of the specific bucket of the cloud storage and the plurality of objects.

In yet another example, the creating the bookmark includes adding the references to the at least one of the plurality of objects to the bookmark.

In yet another example, the creating the bookmark further includes: downloading a manifest file of the dataset, the manifest file identifying the plurality of objects; modifying the manifest file by adding or deleting at least one of the plurality of objects from the manifest file; and updating the manifest file of the dataset for the bookmark.

In yet another example, the method further includes: downloading, by one or more processors, the dataset based on the bookmark to storage in the machine learning platform; and training, by one or more processors, the machine learning model using the downloaded dataset.

In yet another example, operations utilizing the bookmark are processed through cloud storage APIs. In yet another example, the plurality of objects in the bookmark are stored in a plurality of different buckets in the cloud storage. In yet another example, the bookmark comprises metadata including a name, identifier, and version of the bookmark.

Another aspect of the disclosure provides for a system including: one or more processors; and one or more storage devices coupled to the one or more processors and storing instructions that, when executed by the one or more processors, cause the one or more processors to perform operations for controlling a bookmark, the operations including: selecting a plurality of objects for training a machine learning model; processing the plurality of objects by composing a dataset with the plurality of objects; exporting the dataset to a bucket in a cloud storage; and creating a bookmark, wherein the bookmark comprises references to at least one of the plurality of objects.

In an example, the bookmark may be created in a specific bucket of the cloud storage. In another example, the references may be uniform resource identifiers (“URIs”), comprising names and versions of the specific bucket of the cloud storage and the plurality of objects.

In yet another example, creating the bookmark includes adding the references to the at least one of the plurality of objects to the bookmark.

In yet another example, creating the bookmark further includes: downloading a manifest file of the dataset, the manifest file identifying the plurality of objects; modifying the manifest file by adding or deleting at least one of the plurality of objects from the manifest file; and updating the manifest file of the dataset for the bookmark.

In yet another example, the system further includes: downloading, by one or more processors, the dataset based on the bookmark to storage in the machine learning platform; and training, by one or more processors, the ML model using the downloaded dataset.

In yet another example, operations utilizing the bookmark are processed through cloud storage APIs. In yet another example, the plurality of objects in the bookmark are stored in a plurality of different buckets in the cloud storage. In yet another example, the bookmark comprises metadata including a name, identifier, and version of the bookmark.

Yet another aspect of the disclosure provides for a non-transitory computer readable medium for storing instructions that, when executed by one or more processors, cause the one or more processors toto perform operations for managing AI/ML datasets in cloud storage, the operations including: selecting a plurality of objects for training a ML model; processing the plurality of objects by composing a dataset with the plurality of objects; copying the dataset to a bucket in a cloud storage; and creating a bookmark, wherein the bookmark comprises references to at least one of the plurality of objects.

In an example, creating the bookmark further includes: downloading a manifest file of the dataset, the manifest file identifying the plurality of objects; modifying the manifest file by adding or deleting at least one of the plurality of objects from the manifest file; and updating the manifest file of the dataset for the bookmark.

### BRIEF DESCRIPTION OF THE DRAWINGS

FIG. 1 depicts a block diagram of an example cloud storage resource for training ML models according to aspects of the disclosure.

FIG. 2 depicts a block diagram of an example data flow of the ML platform for training ML models according to aspects of the disclosure.

FIG. 3 is a diagram of an example metadata relationship between bookmarks and objects according to aspects of the disclosure.

FIG. 4 depicts a diagram of an example bookmark and objects within datasets in cloud storage according to aspects of the disclosure.

FIG. 5 depicts a flow diagram of an example process for controlling a bookmark in cloud storage according to aspects of the disclosure.

FIG. 6 depicts a block diagram of an example computing environment implementing an example ML system according to aspects of the disclosure.

### DETAILED DESCRIPTION

Generally disclosed herein are implementations for an ML platform for managing artificial intelligence and machine learning (“AI/ML”) datasets in cloud storage, especially for creating and controlling bookmarks or other references in cloud storage for a dataset selected for use for training ML models. The ML platform may be configured to create a reference, referred to herein as a bookmark, in cloud storage. The ML platform may collect objects from the dataset previously used for the ML training, to be utilized in the subsequent training. The ML platform may include the collected objects under a created bookmark. A bookmark may contain references to at least one of the objects within the dataset used in previous training. This enables effective ML training without repeatedly copying the datasets used for training to cloud storage.

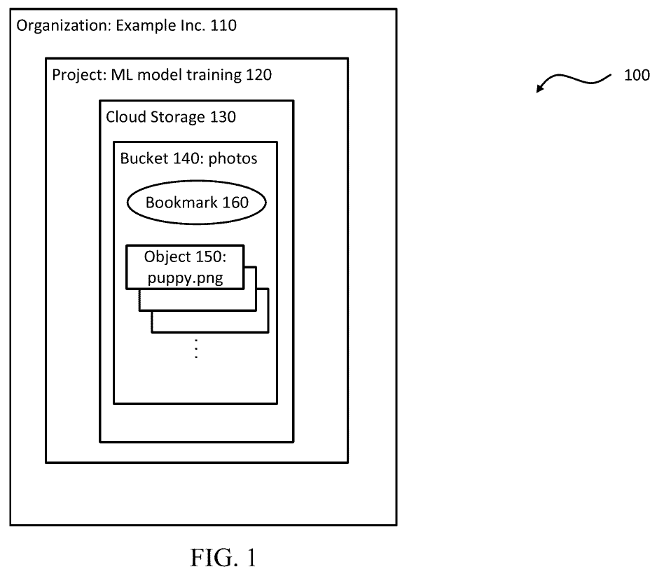

FIG. 1 depicts a block diagram of an example cloud storage resource 100 for training ML models according to aspects of the disclosure. Cloud storage 130 is a service that stores the object 150 in the cloud. The object 150 is an immutable piece of data consisting of a file of any format. Bucket 140 is the basic container that holds objects 150. All objects 150 stored in cloud storage can be contained in a bucket 140. Every bucket 140 may be associated with a project 120, and projects 120 may be grouped under an organization 110. Each project 120, bucket 140, and object 150 in the cloud are resources in the cloud. After a project 120 is created for the ML model training, the corresponding bucket 140 can also be created.

Bookmark 160 is a new type of cloud storage resource which can reside under a bucket 140. The bookmark 160 is a set of object references that are used as training data for the ML model. The bookmark 160 can be used for grouping, providing access control, and downloading objects in bulk. The object reference refers to an existing object 150 and includes a uniform resources identifier (“URI”) of the object 150. The bookmark 160 can contain object references that refer to existing objects 150 in the cloud.

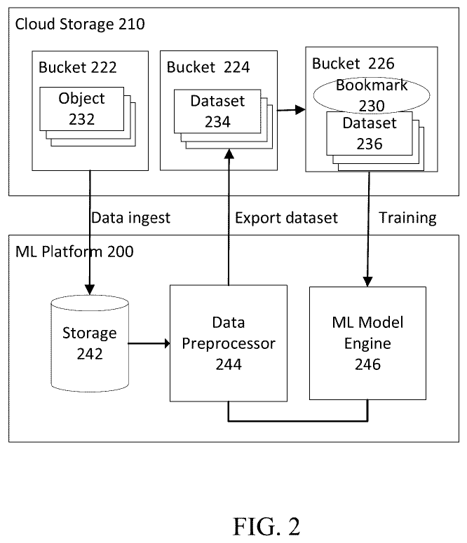

FIG. 2 depicts a flow diagram of an example data flow of the ML platform 200 for training ML models according to aspects of the disclosure. The ML platform 200 can prepare datasets for training ML models. The ML platform 200 can be configured to ingest data objects 232 to the local storage 242 from the various sources such as cloud storage 210. Since the ingested data objects 232 can be incomplete or contain noise, the data preprocessor 244 of the ML platform 200 can perform the process of refining and preprocessing the ingested data object 232. During the process, the data preprocessor 244 can generate or modify new features in the data, reconstructing it into meaningful datasets. The reconstructed dataset is structured as a logical dataset for the model training and compiled into a single dataset, then exported to a bucket 224 in the cloud storage 210.

Typically, the ML platform can copy the exported dataset to a specific bucket in the cloud storage for reproducibility and compliance of the ML model. In the ML data workflows, the ML platform can be required to preserve the training data exactly as it was used for training to meet the compliance requirement of providing a direct lineage between the ML model and training data. After copying the exported dataset to the specific bucket, the ML platform 200 can download the dataset using APIs provided by the storage service provider to the local memory for the training. The ML platform 200 can train the ML model using the downloaded dataset, evaluate the model using a validation process, and refine the performance. The ML platform can retrain the refined ML model with a new dataset, aiming to deploy the optimal ML model.

The ML platform 200 can create bookmark 230 for the subsequent rounds of training the ML model. The bookmarks 230 can serve as a mechanism for the ML platform 200 to preserve a collection of objects. A manifest file may be created when the bookmarks are created. The manifest file can list the paths of the collection of objects in the bookmarks. The bookmarks 230 serve as references to objects within the dataset 234 in the buckets 244 to preserve a dataset without repeatedly copying the objects selected for training. The dataset 236 can include at least one of the objects within the dataset 234, and the objects of the dataset 236 are not copied to any bucket physically, but are referenced by the bookmark 230.

Bookmarks can store references to objects with versions. Creating a bookmark can require a new version ID of the bookmark. Each bookmark can have a URI with the name of the project, bucket, bookmark, and version ID, enabling unique identification. For example, the bookmark URIs with versions are as follows:
Bucket: projects/_/buckets/my-bucket-1
Bookmark version:
projects/_/buckets/my-bucket-1/bookmarks/my-bookmark-1 #987654321

Each object within the dataset can also have a URI with the name of project, bucket, object and version ID. For example, existing resource and URIs of an object with version are as follows:
Bucket: projects/_/buckets/my-bucket-1
Object generation in Bucket:
projects//buckets/my-bucket-1/objects/my-object-1 #123456789

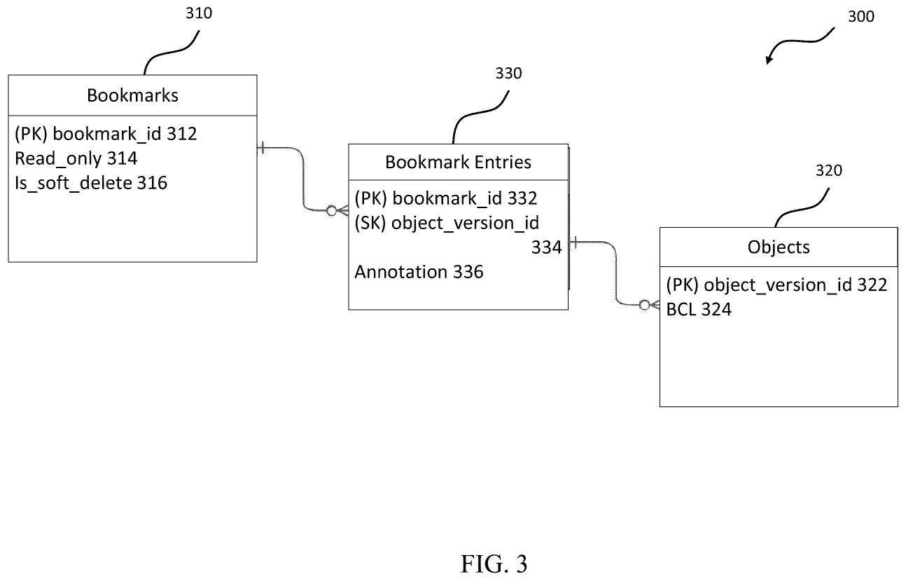

FIG. 3 illustrates an example metadata 300 relationship between bookmarks and objects. The metadata 300 can include bookmark metadata 310 and object metadata 320. Bookmark metadata 310 can include a bookmark ID 312, serving as a primary key for queries, and attributes of the bookmark such as read-only 314 or soft-delete features 316. Object metadata 320 can include an object version ID 322 which can be a primary key for queries, and attributes 324 related to the object. Bookmark entries 330 can include the bookmark ID 332, which may have the same value of the bookmark ID 312 stored in the metadata of the bookmark, as a primary key. Further, the bookmark entries 330 can include the object version ID 334, which may have the same value of the object version ID 322 stored in the metadata of the object as a secondary key. The bookmark entries 330 can establish the connection between the bookmark and object using the bookmark ID 332 and object version ID 334 as a primary key and secondary key, enabling the bookmark to reference the object.

As another example, the object metadata may be copied to a new bucket when a new bookmark is created, without copying the actual object version. This new bucket could be hidden and encapsulated in a bookmark, or shown as a special bucket to the user that represents a dataset. Copying of the metadata may be limited to only those objects that are included in the bookmark. When cloud storage has any metadata that references an object version, the object version is preserved, so the objects from the original bucket would not be deleted. Using this approach, metadata may be copied from different buckets into the same bucket if the bookmark had objects that spanned multiple buckets.

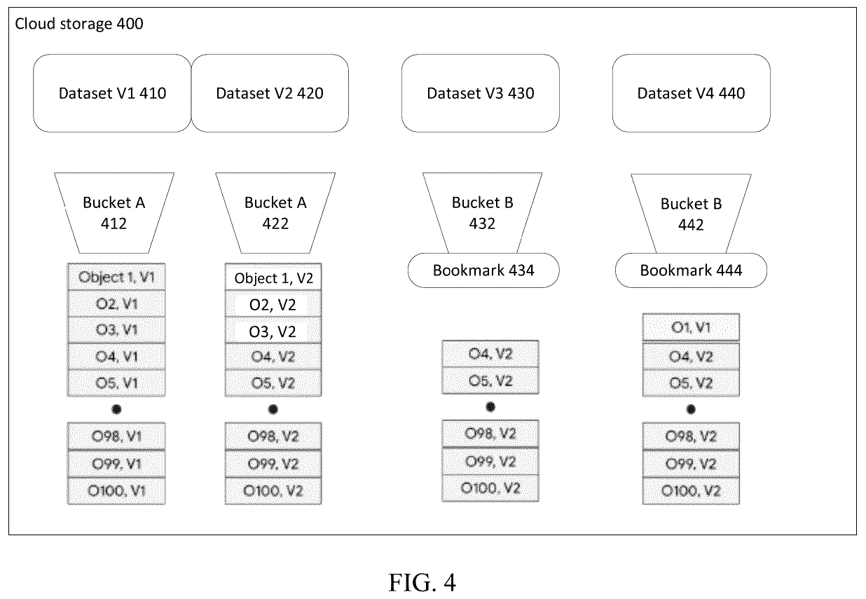

FIG. 4 depicts the diagram of an example bookmarks and objects within datasets in cloud storage 400 according to aspects of the disclosure. The ML platform 200, as depicted in FIG. 2, can collect the dataset V1 410 from the various cloud storage and store it in a bucket A 412 for the ML model training. For example, the dataset V1 410 can include objects O1-O100 and each object has an object version ID, such as O1, V1. This configured dataset is version-controlled, and each object within the dataset also contains version information. For the data preprocessing, the ML platform 200 can ingest dataset V1 410 to the local memory. During the data preprocessing, the dataset V1 410 can be reconstructed, involving standardizing, extracting features and labeling the plurality of objects. The preprocessed dataset is exported to the bucket A 422 in cloud storage by the ML platform 200. The exported dataset V2 420 can include all or some of the objects from the dataset V1 410. Each object of the dataset V2 420 can have a new object version ID, such as O1, V2. The ML platform 200 can utilize the dataset V2 420 to train the ML model.

After completing the model training using dataset V2 420, the ML platform 200 reconfigures a new dataset and creates a bookmark to perform training again with the adjusted ML model. As shown in FIG. 4, the ML platform 200 can create a new bucket B 432 for the subsequent rounds of training and create a bookmark 434 under the bucket B 432. The bookmark 434 includes objects from the previously configured dataset. The bookmark can include references to at least one of the objects within the dataset V1 410 and V2 420. For example, the ML platform 200 can configure a new dataset V3 430 using the bookmark 434. The bookmark 434 can include references to objects O4-O 100 from the dataset V2 420 with version IDs. Using the dataset V3 430, the ML platform 200 can proceed with the subsequent rounds of training.

To further train with the adjusted ML model, a new dataset V4 440 can be configured. For the dataset V4 440, a new bookmark 444 can be created in the same bucket B 442, and objects for training are selected. For example, the bookmark 444 can include the object O1 from dataset V1 410 and objects O 4-O 100 from dataset V2 420. For example, the objects for bookmarks can extend across multiple buckets. In some examples, the objects can be referenced by one or more bookmarks and the objects that are referenced by one or more bookmarks cannot be deleted. In some examples, multiple bookmarks can be created in a single bucket, multiple bookmarks can be created in multiple buckets, and furthermore, the same bookmark can be utilized in multiple buckets.

During the iterative process of the ML model training, the ML platform 200 can call APIs to create the bookmark. Cloud storage APIs can support bookmarks as an alternative container, facilitating operations such as initialization, object listing, and retrieval through existing interfaces. Utilizing existing APIs enables the creation of bookmarks, reading specific bookmark metadata, listing objects within a bookmark, and bookmarks within a designated bucket. The bookmark initialization can involve creating or copying bookmarks.

During the initialization phase, the ML platform 200 can manage object additions or removals within bookmarks. The initialization operation can be completed after performing an access check to create the bookmark, adding or removing the objects, and storing the metadata associated with the objects. For example, a cloud storage platform can perform access checks to ensure that the ML platform has permission to create and modify bookmarks. If the ML platform has permission, the ML platform can add or remove objects to bookmarks, which can be similar to copy or delete object operations.

The bookmarks can utilize existing manifest files of the objects with incremental differences, to allow for small updates. The ML platform 200 can download the manifest file from the datasets and make alterations, such as adding or deleting objects. The ML platform 200 can call the API for the creation of a new bookmark with the updated manifest file. To apply the updated manifest to an existing bookmark, the ML platform can create a new version for the bookmark with metadata that tracks the new changes to the manifest. For example, the function ‘List Objects’ is used to retrieve the object manifest. Existing List Object APIs can support bookmarks as an alternative container instead of bucket. For example, cloud service providers can provide APIs that enable application of the updated manifest to the existing bookmark.

Once all desired objects are in a bookmark, the bookmark can be finalized, rendering the objects in the bookmark immutable and available for downloading in bulk. In some examples, the finalized bookmark cannot be reverted and can either be deleted or copied. To modify the contents of a finalized bookmark, the finalized bookmark needs to be copied to a new initializing bookmark. Finalizing a bookmark involves specifying a parent bucket and ID, conducting an access check, updating metadata, and then completing the process.

The ML platform 200 may need to rapidly download all objects from a bookmark to a local cache. Bookmarks can facilitate operations for reading all objects in the manifest through an API provided by the cloud storage platform. For example, this API can be optimized for high-speed reading throughput while maintaining low latency. After performing access checks for the bookmark, the ML platform 200 can determine the list of objects in the bookmark, and then provide a stream of these objects for downloading using the API. The stream of objects can contain object metadata such as name, checksum, content size, and the raw byte contents of the object. The output stream can utilize multi-body HTTP or streaming remote procedure calls (“RPCs”) provided by the cloud storage platform. The API can be designed to support partitioning, enabling multiple threads or processes in parallel to enhance overall throughput. This API can only be available for finalized bookmarks, because changes to the bookmark during a download would cause data consistency issues.

Deleting a bookmark is a soft delete operation, which means it moves to a recoverable soft-deleted state before a potential hard deletion. When the bookmark is hard deleted, all related references are purged. Soft deleting a bookmark can be marked for hard deletion in the future. While in a soft-deleted state, bookmarks cannot be mutated or list objects. After a period of time, the bookmark and all of its entries can be deleted.

Copying a bookmark is a long-running operation (“LRO”). Copying a bookmark can include copying the objects of the bookmark that is distinct from the original bookmark by a version ID. This operation requires a parent project and bookmark ID. Once all the internal LRO steps are completed, the bookmark can be used like any other bookmark. To speed up copying, the ML platform 200 can use methods such as incremental, differential copy and offline metadata copy. Copying is a metadata-only operation that references existing bookmarks. After the initial copy is created, deletions can be marked with a tombstone in the bookmark entries table. The offline operation can create a full copy of the metadata with the new bookmark ID and deletes any tombstones.

Bookmarks can also facilitate faster access and permission to all objects within the bookmark, which enables swift downloads. Cloud storage can guarantee the immutability of objects within bookmarks for as long as the bookmark exists, which ensures consistent data retrieval. Therefore, the ML platform 200 can be configured to store all finalized datasets in a version-enabled single bucket, updating objects in cloud storage that have been modified between datasets. This approach allows the ML platform 200 to associate object versions with bookmarks and to make bookmarks immutable, thereby preserving all object versions within bookmarks.

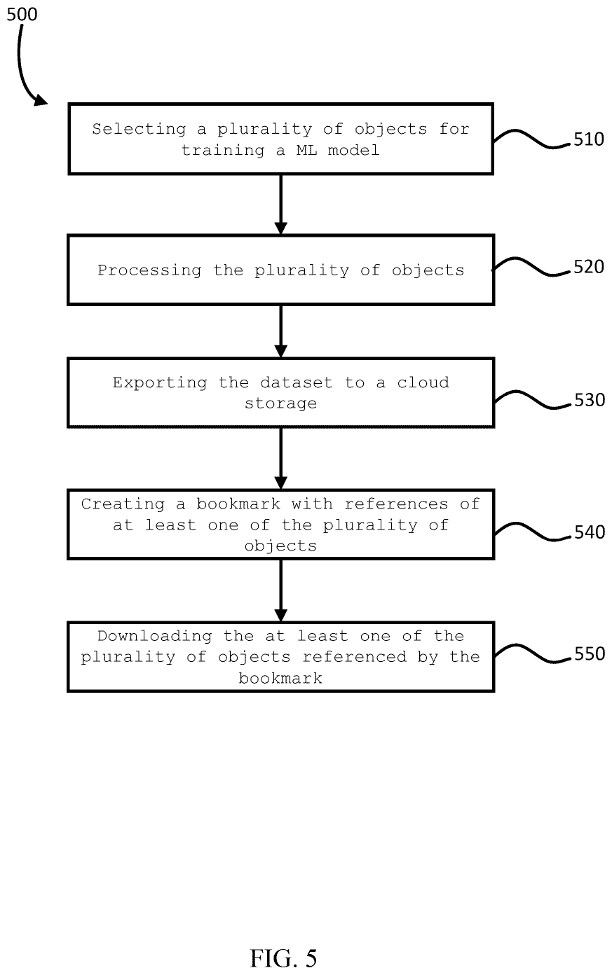

FIG. 5 depicts flow diagrams of an example process 500 for controlling a bookmark in cloud storage. The example process 500 can be performed on a system of one or more processors in one or more locations, such as the ML platform 200 as depicted in FIG. 2. While the operations are described in a particular order below, it should be understood that the order may be modified and operations may be performed in parallel. Moreover, operations may be added or omitted.

As shown in block 510, the ML platform 200 collects a plurality of objects for training an ML model from various sources, such as cloud storage. In cloud storage, an object is a unit of data. For example, objects can be in any format such as photos, audio files, network logs, emails, etc. Moreover, such objects can vary in size. The plurality of objects may exist in any data storage, such as a catalog system outside of cloud storage. The ML platform 200 can select objects according to the purpose of the ML model training, considering attributes such as relevance, diversity, and quality.

The selected objects are imported into the local storage of the ML platform. As shown in block 520, the ML platform 200 processes the selected objects to suit the purpose of the ML model training. The processing of the selected objects can involve constructing and transforming the dataset. During the construction of the dataset, the ML platform performs the processes of extracting features of objects, labeling objects, sampling, and splitting objects. These processes can be determined by what the ML model is trying to predict and what features are desired. Following this, the data is transformed, including data cleansing and feature engineering for data compatibility or quality improvement to enhance the model performance.

After the dataset construction and transformation are finished, the dataset is exported to cloud storage for the ML model training. As shown in block 530, the ML platform 200 exports the dataset to cloud storage. The ML platform 200 can utilize the APIs or SDKs provided by the cloud service provider to create a new bucket and then export the training dataset into the created bucket. As the bucket is being created, access permissions and security settings for the training dataset in the new bucket are adjusted as needed. Further, the ML platform 200 can establish the necessary security policies to maintain the confidentiality and security of the data.

As shown in block 540, the ML platform 200 creates a bookmark with references to at least one of the plurality of objects within the dataset for the subsequent rounds of training. After access checks by the cloud storage platform, the ML platform 200 can call

APIs to create the bookmark. The bookmarks are created within a single bucket by combining objects and versions from other cloud storage buckets. The objects for bookmarks can extend across multiple buckets. The ML platform 200 can manage object additions or removals within bookmarks and create metadata for bookmarks and objects. For example, the ML platform 200 calls cloud storage APIs to add or remove objects from bookmarks. Cloud storage performs access checks for the ML platform 200 adding and removing, to determine whether the ML platform 200 is allowed to modify the bookmark. Cloud storage platform creates metadata for the object reference when it's added. The metadata is stored in the cloud storage's metadata storage.

As shown in block 550, the ML platform 200 downloads at least one of the plurality of objects referenced by the bookmark. The ML platform 200 may require downloading all objects in a bookmark to local cache as fast as possible. Bookmarks can support operations for reading all objects in the manifest through an API that is optimized for high read throughput with low latency.

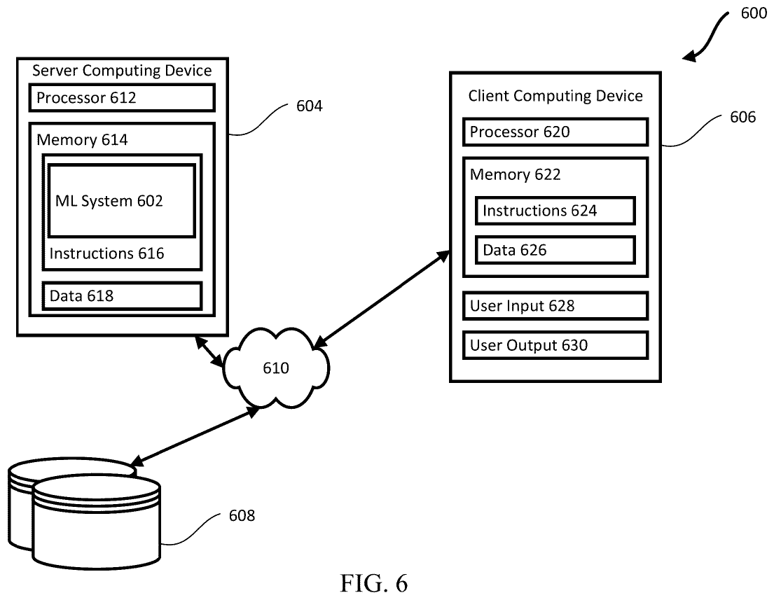

FIG. 6 depicts a block diagram of an example computing environment 600 implementing an example ML system 602. The ML system can be implemented through the ML platform, which provides tools and environments to implement and run the ML system. For example, the ML system 602 can be the ML platform 200 described in FIG. 2. The ML system 602 can be implemented on one or more devices having one or more processors in one or more locations, such as in server computing device 604. The ML system can include one or more AI/ML engines, modules, or models. The AI/ML engines, modules, or models can be implemented as one or more computer programs, specially configured electronic circuitry, or any combination thereof. The AI/ML engines, modules, or models can be configured to create and control bookmarks for datasets used to select for training ML models.

User computing device 606 and the server computing device 604 can be communicatively coupled to one or more storage devices 608 over a network 610. The storage devices 608 can be a combination of volatile and non-volatile memory and can be at the same or different physical locations than the computing devices 604, 606. For example, the storage device(s) 608 can include any type of non-transitory computer readable medium capable of storing information, such as a hard-drive, solid state drive, tape drive, optical storage, memory card, ROM, RAM, DVD, CD-ROM, write-capable, and read-only memories. Cloud storage is a mode of computer data storage in which digital data is stored on one or more storage devices 608 over a network 610.

The server computing device 604 can include one or more processors 612 and memory 614. The memory 614 can store information accessible by the processors 612, including instructions 616 that can be executed by the processors 612. The memory 614 can also include data 618 that can be retrieved, manipulated, or stored by the processors 612. The memory 614 can be a type of transitory or non-transitory computer readable medium capable of storing information accessible by the processors 612, such as volatile and non-volatile memory. The processors 612 can include one or more central processing units (CPUs), graphic processing units (GPUs), field-programmable gate arrays (FPGAs), and/or application-specific integrated circuits (ASICs), such as tensor processing units (TPUs).

The instructions 616 can include one or more instructions that, when executed by the processors 612, cause the one or more processors 612 to perform actions defined by the instructions 616. The instructions 616 can be stored in object code format for direct processing by the processors 612, or in other formats including interpretable scripts or collections of independent source code modules that are interpreted on demand or compiled in advance. The instructions 616 can include instructions for implementing ML system 602. The ML system 602 can be executed using the processors 612, and/or using other processors remotely located from the server computing device 604.

The data 618 can be retrieved, stored, or modified by the processors 612 in accordance with the instructions 616. The data 618 can be stored in computer registers, in a relational or non-relational database as a table having a plurality of different fields and records, or as JSON, YAML, proto, or XML documents. The data 618 can also be formatted in a computer-readable format such as, but not limited to, binary values, ASCII or Unicode. Moreover, the data 618 can include information sufficient to identify relevant information, such as numbers, descriptive text, proprietary codes, pointers, references to data stored in other memories, including other network locations, or information that is used by a function to calculate relevant data.

The user computing device 606 can also be configured similar to the server computing device 604, with one or more processors 620, memory 622, instructions 624, and data 626. The user computing device 606 can also include a user input 628, and a user output 630. The user input 628 can include any appropriate mechanism or technique for receiving input from a user, such as keyboard, mouse, mechanical actuators, soft actuators, touchscreens, microphones, and sensors.

The server computing device 604 can be configured to transmit data to the user computing device 606, and the user computing device 606 can be configured to display at least a portion of the received data on a display implemented as part of the user output 630. The user output 630 can also be used for displaying an interface between the user computing device 606 and the server computing device 604. The user output 630 can alternatively or additionally include one or more speakers, transducers or other audio outputs, a haptic interface or other tactile feedback that provides non-visual and non-audible information to the user of the user computing device 606.

Although FIG. 6 illustrates the processors 612, 620 and the memories 614, 622 as being within the computing devices 604, 606, components described herein, including the processors 612, 620 and the memories 614, 622 can include multiple processors and memories that can operate in different physical locations and not within the same computing device. For example, some of the instructions 616, 624 and the data 618, 626 can be stored on a removable SD card and others within a read-only computer chip. Some or all of the instructions 616, 624 and data 618, 626 can be stored in a location physically remote from, yet still accessible by, the processors 612, 620. Similarly, the processors 612, 620 can include a collection of processors that can perform concurrent and/or sequential operations. The computing devices 604, 606 can each include one or more internal clocks providing timing information, which can be used for time measurement for operations and programs run by the computing devices 604, 606.

The server computing device 604 can be configured to receive requests to process data from the user computing device 606. For example, the environment 600 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing device 606 may receive and transmit data specifying target computing resources to be allocated for executing a neural network trained to perform a particular neural network task.

The computing devices 604, 606 can be capable of direct and indirect communication over the network 610. The computing devices 604, 606 can set up listening sockets that may accept an initiating connection for sending and receiving information. The network 610 can include various configurations and protocols including the Internet, World Wide Web, intranets, virtual private networks, wide area networks, local networks, and private networks using communication protocols proprietary to one or more companies. The network 610 can support a variety of short- and long-range connections. The short- and long-range connections may be made over different bandwidths, such as 2.402 GHz to 2.480 GHZ (commonly associated with the Bluetooth® standard), 2.4 GHZ and 5 GHZ (commonly associated with the Wi-Fi® communication protocol); or with a variety of communication standards, such as the LTER standard for wireless broadband communication. The network 610, in addition or alternatively, can also support wired connections between the computing devices 604, 606, including over various types of Ethernet connection.

Although a single server computing device 604 and user computing device 606 are shown in FIG. 6, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for managing artificial intelligence and machine learning (AI/ML) datasets in cloud storage, the method comprising:
selecting, by one or more processors, a plurality of objects for training a machine learning model;
processing, by one or more processors, the plurality of objects by composing a dataset with the plurality of objects;
exporting, by one or more processors, the dataset to a bucket in a cloud storage; and
creating, by one or more processors, a bookmark, wherein the bookmark comprises references to at least one of the plurality of objects.

2. The method of claim 1, wherein the bookmark is created in a specific bucket of the cloud storage.

3. The method of claim 2, wherein the references are uniform resource identifiers (URIs), comprising names and versions of the specific bucket of the cloud storage and the plurality of objects.

4. The method of claim 1, wherein the creating the bookmark comprises adding the references to the at least one of the plurality of objects to the bookmark.

5. The method of claim 1, wherein the creating the bookmark further comprises:
downloading a manifest file of the dataset, the manifest file identifying the plurality of objects;
modifying the manifest file by adding or deleting at least one of the plurality of objects from the manifest file; and
updating the manifest file of the dataset for the bookmark.

6. The method of claim 1, further comprising:
downloading, by one or more processors, the dataset based on the bookmark to storage in the machine learning platform; and
training, by one or more processors, the machine learning model using the downloaded dataset.

7. The method of claim 1, wherein operations utilizing the bookmark are processed through cloud storage APIs.

8. The method of claim 1, wherein the plurality of objects in the bookmark are stored in a plurality of different buckets in the cloud storage.

9. The method of claim 1, wherein the bookmark comprises metadata including a name, identifier, and version of the bookmark.

10. A system comprising:
one or more processors; and
one or more storage devices coupled to the one or more processors and storing instructions that, when executed by the one or more processors, cause the one or more processors to perform operations for managing AI/ML datasets in cloud storage, the operations comprising:
selecting a plurality of objects for training a machine learning model;
processing the plurality of objects by composing a dataset with the plurality of objects;
exporting the dataset to a bucket in a cloud storage; and
creating a bookmark, wherein the bookmark comprises references to at least one of the plurality of objects.

11. The system of claim 10, wherein the bookmark is created in a specific bucket of the cloud storage.

12. The system of claim 11, wherein the references are uniform resource identifiers (URIs), comprising names and versions of the specific bucket of the cloud storage and the plurality of objects.

13. The system of claim 10, wherein the creating the bookmark comprises adding the references to the at least one of the plurality of objects to the bookmark.

14. The system of claim 10, wherein the creating the bookmark further comprises:
downloading a manifest file of the dataset, the manifest file identifying the plurality of objects;
modifying the manifest file by adding or deleting at least one of the plurality of objects from the manifest file; and
updating the manifest file of the dataset for the bookmark.

15. The system of claim 10, further comprising:
downloading, by one or more processors, the dataset based on the bookmark to storage in the machine learning platform; and
training, by one or more processors, the ML model using the downloaded dataset.

16. The system of claim 10, wherein operations utilizing the bookmark are processed through cloud storage APIs.

17. The system of claim 10, wherein the plurality of objects in the bookmark are stored in a plurality of different buckets in the cloud storage.

18. The system of claim 17, wherein the bookmark comprises metadata including a name, identifier, and version of the bookmark.

19. A non-transitory computer readable medium for storing instructions that, when executed by one or more processors, cause the one or more processors to perform operations for managing AI/ML datasets in cloud storage, the operations comprising:
selecting a plurality of objects for training a ML model;
processing the plurality of objects by composing a dataset with the plurality of objects;
copying the dataset to a bucket in a cloud storage; and
creating a bookmark, wherein the bookmark comprises references to at least one of the plurality of objects.

20. The system of claim 19, wherein the creating the bookmark further comprises:
downloading a manifest file of the dataset, the manifest file identifying the plurality of objects;
modifying the manifest file by adding or deleting at least one of the plurality of objects from the manifest file; and
updating the manifest file of the dataset for the bookmark.
